(19) United States
(12) Patent Application Publication
(10) Pub. No.: US 2015/0308936 A1
(43) Pub. Date: Oct. 29, 2015

(54) Frequency Domain Structural Analysis Of A Product Having Frequency-Dependent Material Property

(71) Applicant: Livermore Software Technology Corporation, Livermore, CA (US)

(72) Inventors: Yun Huang, Dublin, CA (US); Dirk Fressmann, Stuttgart (DE)

(73) Assignee: Livermore Software Technology Corporation, Livermore, CA (US)

(21) Appl. No.: 14/264,249

(22) Filed: Apr. 29, 2014

(51) Int. Cl. G01N 3/32; G06F 17/50; G01M 99/00

(52) U.S. Cl. CPC G01N 3/32; G01M 99/007; G06F 17/5018

(57) ABSTRACT

FEA model representing a product made of at least in-part frequency-dependent material and subjected to external harmonic excitations in a range of external excitation frequencies is received in a computer system. The range of frequencies is partitioned into N frequency bands based on predefined criteria. In each frequency band, a representative frequency is selected for calculating the material properties and an eigensolution frequency range is determined for establishing upper and lower limits of subsequent eigensolution. N eigensolutions (one for each frequency band) are performed to extract natural vibration frequencies and associated mode shapes of the product. Depending upon which one of the N frequency bands each of the external harmonic excitations is located, a corresponding set of extracted natural vibration frequencies and mode shapes is selected and used in a modified mode-superposition technique to obtain steady-state dynamic (SSD) responses of the product.

### FIELD

The present invention generally relates to computer-aided engineering analysis of a product (e.g., car, airplane, etc.), more particularly to systems and methods of conducting frequency-domain structural analysis of a product made of at least in-part frequency-dependent material.

### BACKGROUND

Computer aided engineering (CAE) has been used for supporting engineers in many tasks. For example, in a structure or product design procedure, CAE analysis, in particular finite element analysis (FEA), has often been employed to evaluate responses (e.g., stresses, displacements, etc.) under various loading conditions (e.g., static or dynamic).

FEA is a computerized method widely used in industry to simulate (i.e., model and solve) engineering problems relating to complex products or systems (e.g., cars, airplanes, etc.) such as three-dimensional linear and/or non-linear structural design and analysis. FEA derives its name from the manner in which the geometry of the object under consideration is specified. The geometry is defined by elements and nodes. There are many types of elements, solid elements for volumes or continua, shell or plate elements for surfaces and beam or truss elements for one-dimensional structure objects.

One of the challenging FEA tasks is to obtain simulated dynamic structural responses of a product subject to harmonic loadings. Prior art approach has been using frequency-domain analysis/solution. However, such a frequency-domain analysis applies to linear structural behaviors only. In real world, material properties of a product can sometimes be frequency-dependent hence rendering the prior art frequency-domain approach inadequate.

Therefore, it would be desirable to have methods and systems for performing frequency-domain structural analysis of a product made of at least in-part frequency-dependent material.

### SUMMARY

This section is for the purpose of summarizing some aspects of the present invention and to briefly introduce some preferred embodiments. Simplifications or omissions in this section as well as in the abstract and the title herein may be made to avoid obscuring the purpose of the section. Such simplifications or omissions are not intended to limit the scope of the present invention.

Methods and systems for conducting frequency-domain structural analysis of a product made of at least in-part frequency-dependent material are disclosed. According to one aspect, a FEA model representing a product is received in a computer system. The FEA model contains a plurality of nodes connected by a plurality of finite elements. At least one finite element is defined to have the frequency-dependent material property. The product is subjected to external harmonic excitations (e.g., a load spectrum in a range of external excitation frequencies with the load at each frequency represented by an amplitude and a phase angle of a sinusoidal function), which is also received in the computer system. Material properties may include, but not be limited to, mass density, Young's modulus, Poisson's ratio and the likes. One or more application modules configured for a modified mode-superposition technique in frequency-domain structural analysis is installed on the computer system.

The range of frequencies of the external harmonic excitations is partitioned into N frequency bands based on predefined criteria, where N is a positive integer or whole number greater than one (1). One example of the criteria is to ensure that frequency-dependent material property does not vary over certain percentage points (e.g., 5%) within each frequency band.

Then, N eigensolutions (one for each frequency band) are performed to extract natural vibration frequencies (i.e., eigenfrequencies) and associated mode shapes of the product. In each frequency band, a representative frequency is selected for calculating material properties of the product, and an eigensolution frequency range is determined for establishing upper and lower limits of the extracted natural vibration frequencies. The upper and lower limits straddle the frequency band.

External harmonic excitations are then applied using a modified mode-superposition technique to obtain steady-state dynamic (SSD) responses (e.g., nodal velocities or pressures) at desired locations on the product.

Depending upon which one of the N frequency bands each of the external harmonic excitations is located, a corresponding set of extracted natural vibration frequencies and mode shapes is selected and used in a modified mode-superposition technique to obtain steady-state dynamic (SSD) responses of the product.

Objects, features, and advantages of the present invention will become apparent upon examining the following detailed description of an embodiment thereof, taken in conjunction with the attached drawings.

### BRIEF DESCRIPTION OF THE DRAWINGS

These and other features, aspects, and advantages of the present invention will be better understood with regard to the following description, appended claims, and accompanying drawings as follows:

FIG. 1 is a flowchart illustrating an example process of conducting frequency-domain structural analysis of a product made of at least in-part frequency-dependent material, according to one embodiment of the present invention;

FIG. 2 is a diagram showing an example FEA model;

FIG. 3 is a diagram showing a numerical representation of external harmonic excitations in a range of external excitation frequencies, according to an embodiment of the present invention;

FIG. 4 is a diagram illustrating an example scheme to partition the range of frequencies into N frequency bands according to one embodiment of the present invention;

FIG. 5 is a diagram showing an example SSD response of a product obtained via a mode-superposition technique, according to one embodiment of the present invention; and

FIG. 6 is a function block diagram showing salient components of an example computer system, in which one embodiment of the present invention may be implemented.

### DETAILED DESCRIPTIONS

In the following description, numerous specific details are set forth in order to provide a thorough understanding of the present invention. However, it will become obvious to those skilled in the art that the present invention may be practiced without these specific details. The descriptions and representations herein are the common means used by those experienced or skilled in the art to most effectively convey the substance of their work to others skilled in the art. In other instances, well-known methods, procedures, and components have not been described in detail to avoid unnecessarily obscuring aspects of the present invention.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams representing one or more embodiments of the invention do not inherently indicate any particular order nor imply any limitations in the invention.

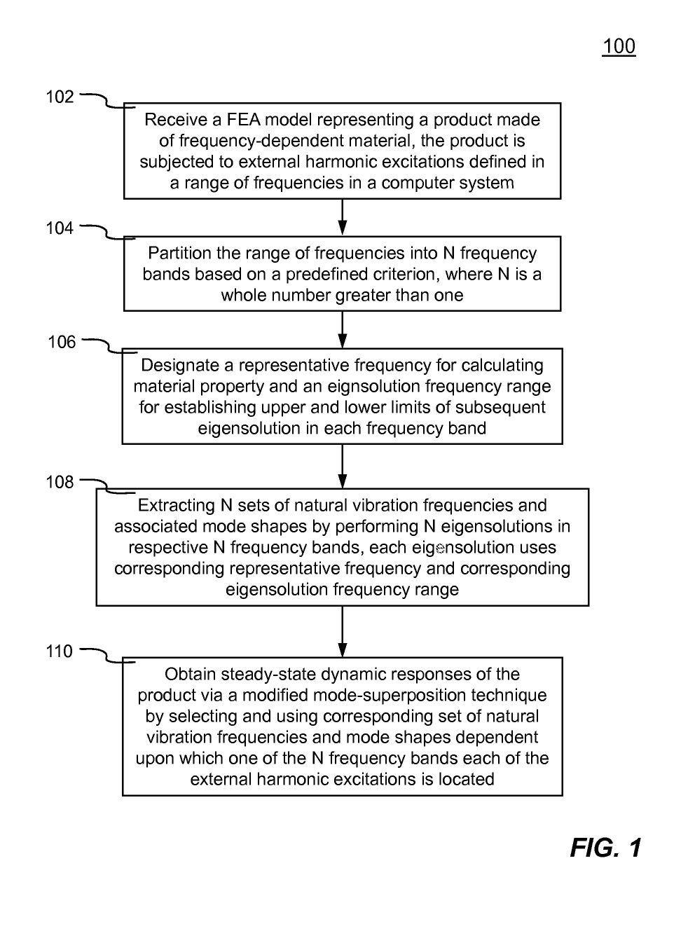

Embodiments of the present invention are discussed herein with reference to FIGS. 1-6. However, those skilled in the art will readily appreciate that the detailed description given herein with respect to these figures is for explanatory purposes as the invention extends beyond these limited embodiments.

Referring first to FIG. 1, it is shown a flowchart illustrating an exemplary process 100 of conducting frequency-domain structural analysis of a product made of at least in-part frequency-dependent material. Process 100 is implemented in software and understood with other figures.

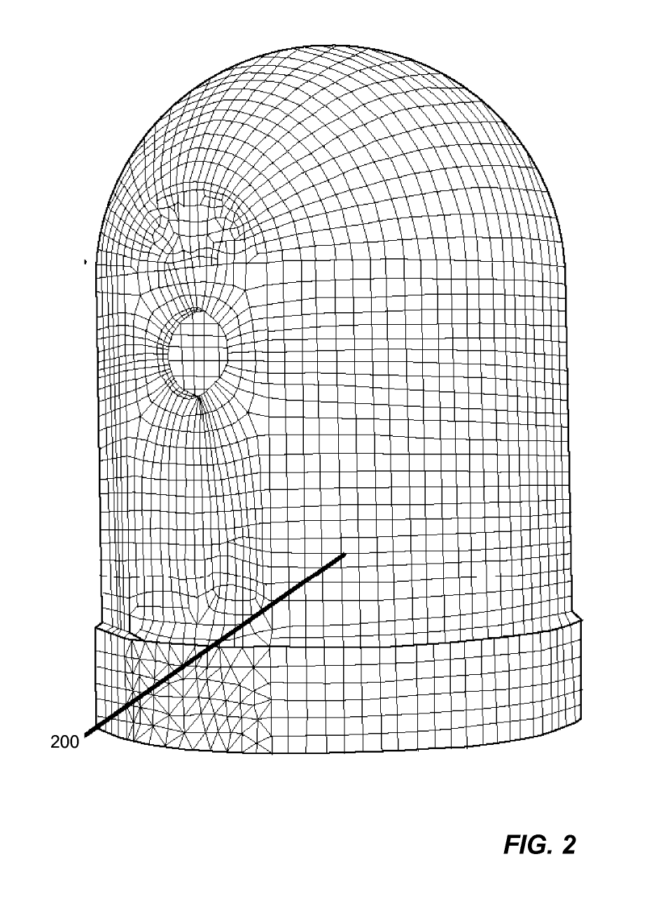

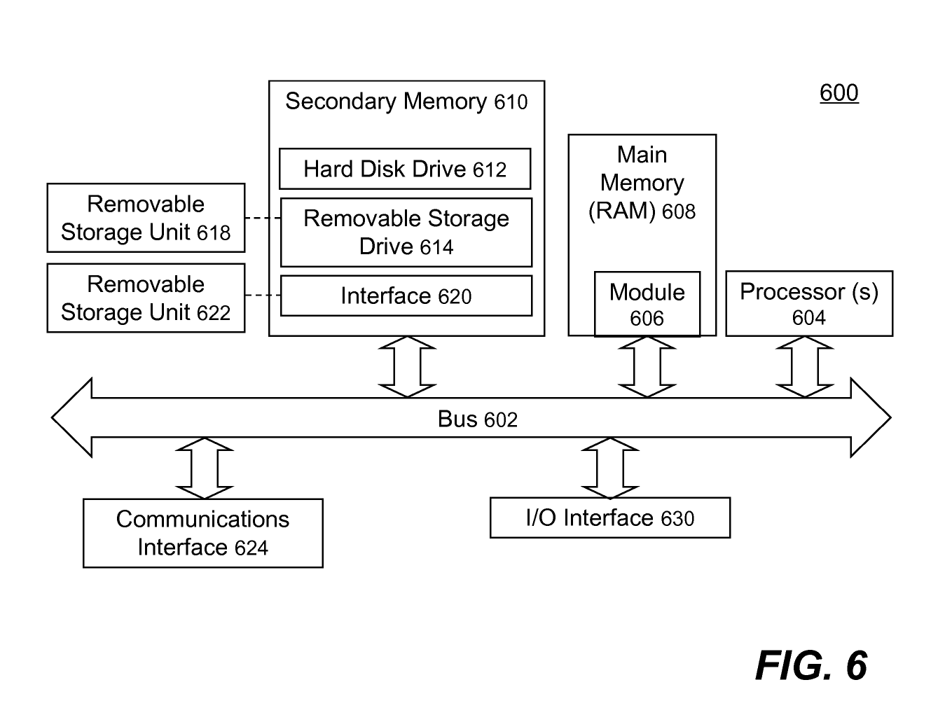

Process 100 starts at step 102 by receiving a finite element analysis (FEA) model representing a product in a computer system (e.g., computer 600 of FIG. 6). The product is made of at least in-part frequency-dependent material and subjected to external harmonic excitations. Examples of a product include, but are not limited to, an automobile, an airplane, and their components. An example FEA model 200 is shown in FIG. 2. A FEA model generally contains a number of nodal points connected by a number of finite elements (i.e., beam, shell and/or solid elements). At least one finite element is defined to have frequency-dependent material property. Example material properties include, but are not limited to, mass density, Young's modulus, and Poisson ratio. In other words, the product can have different mass under different external excitations thereby resulting into different structural dynamic characteristics (i.e., natural vibration frequencies and associated mode shapes).

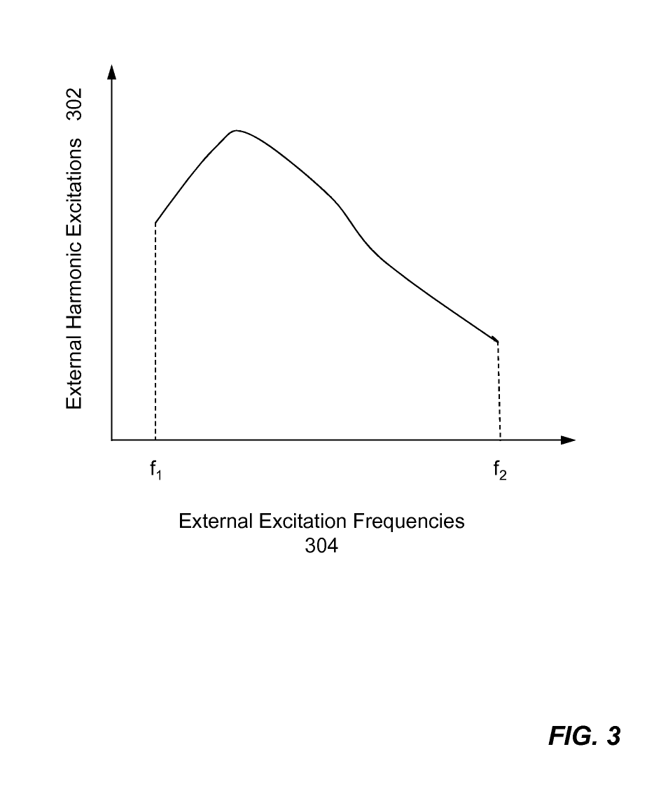

Also received in the computer system is a definition of external harmonic excitations in a range of external excitation frequencies. An example of which is shown in FIG. 3 as external harmonic excitations 302 versus external excitation frequencies 304 (i.e., a range of external excitation frequencies between f₁ and f₂).

At step 104, the range of frequencies is partitioned into N frequency bands based on a predefined criterion. N is a whole number or positive integer greater than one (1). One example of the criterion is to limit material property variation within a predetermined percentage (e.g., 5%). One object of partitioning the range of the frequencies is to minimize the effort to conduct eigensolutions and to increase the accuracy for conducting frequency domain dynamic analysis for frequency-dependent materials using the modified mode-superposition technique. For each of the N frequency bands, a representative frequency for calculating material properties and an eigensolution frequency range for establishing upper and lower limits of subsequent eigensolution are designated at step 106.

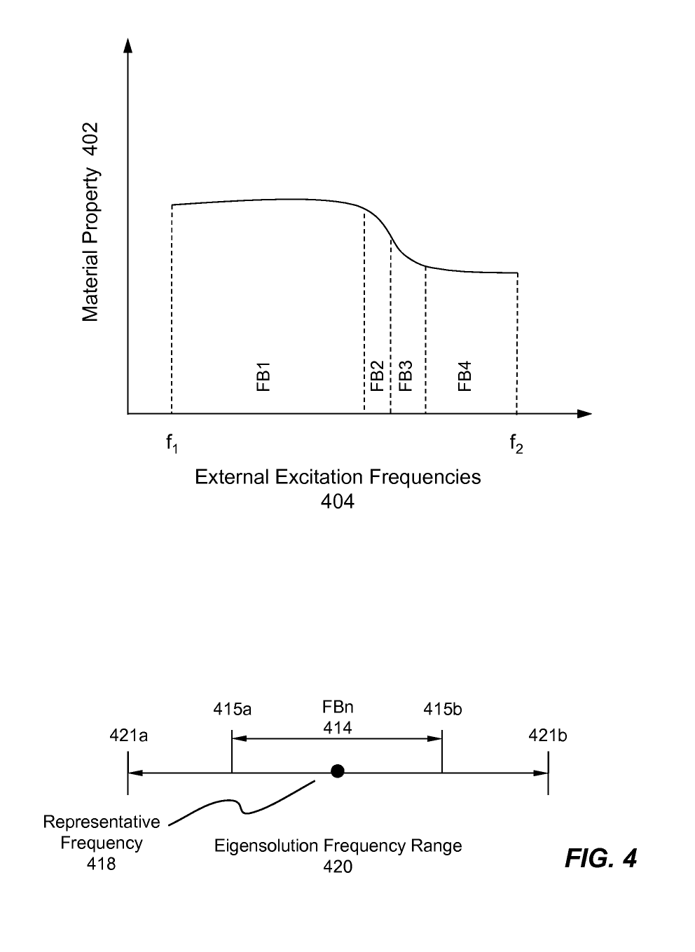

The representative frequency for each frequency band can be any frequency within that frequency band (e.g., the middle value of the frequency band). An example shown in FIG. 4 shows material property 402 versus external excitation frequencies 404. Based on a predefined criterion, the range of external excitation frequencies is divided or partitioned into four frequency bands (i.e., FB1, FB2, FB3 and FB4). In each frequency band shown as FBn 414, a representative frequency 418 is designated for calculating material properties and an eigensolution frequency range 420 is determined for establishing upper and lower limits 421a-421b of subsequent eigensolution. Upper and lower limits 421a-421b generally straddle the frequency band FBn 414. One technique is to add a range at either ends 415a-415b of the frequency band FBn 414 to determine the eigensolution frequency range 420. For example, for frequency band [fᵢ¹, fᵢ²] having a width Δfᵢ=fᵢ²−fᵢ¹, the upper and lower limits can be defined, by adding 20% of the width at either ends of the frequency band, as Fᵢ^{l}=fᵢ¹−Δfᵢ×20% and Fᵢ^{u}=fᵢ²+Δfᵢ×20%.

Next, at step 108, N sets of natural vibration frequencies and associated mode shapes are extracted by performing N eigensolutions in respective N frequency bands. Each eigensolution uses the FEA model with material properties calculated from the corresponding representative frequency and uses the upper and lower limits of the corresponding eigensolution frequency range of said each of the N frequency bands.

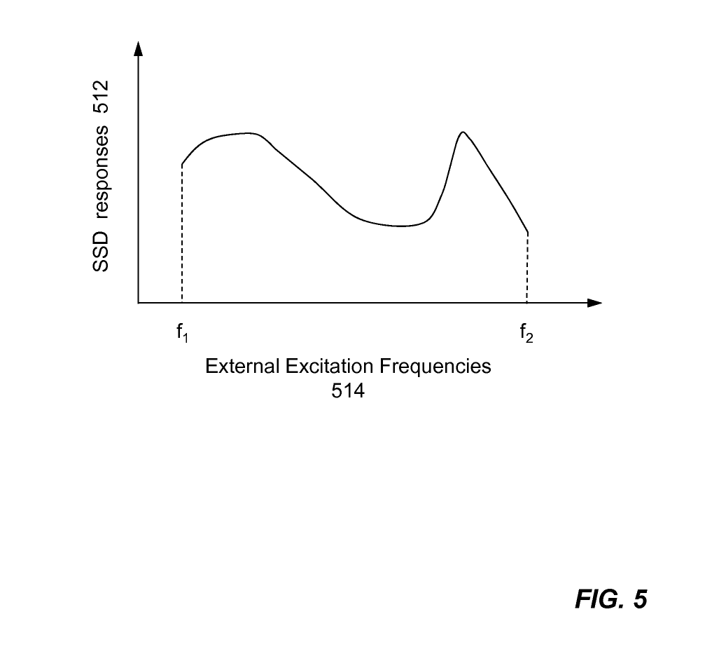

Finally, at step 110, steady-state dynamic (SSD) responses of the product are obtained via a modified mode-superposition technique by selecting and using corresponding set of natural vibration frequencies and mode shapes dependent upon which one of the N frequency bands each of the external harmonic excitations is located. FIG. 5 shows SSD responses 512 versus external excitation frequencies 514.

Modified mode-superposition technique is based on the following equations:

M\ddot{x}+C\dot{x}+Kx=f

where M is mass matrix, C is damping, K is stiffness, f is external loads in time domain.

When both the external excitation and responses of the system are harmonic, the above equation can be written as:

−ω²Mx(ω)+iωCx(ω)+Kx(ω)=f(ω)

where ω is round or circular frequency, M is mass matrix, C is damping, K is stiffness, f(ω) is external loads in frequency domain.

x=Σᵢ₌₁ⁿyᵢφᵢ

where x is displacement, yᵢ is modal coordinates and φᵢ is mode shapes.

According to another aspect, the present invention is directed towards one or more computer systems capable of carrying out the functionality described herein. An example of a computer system 600 is shown in FIG. 6. The computer system 600 includes one or more processors, such as processor 622. The processor 622 is connected to a computer system internal communication bus 620. Various software embodiments are described in terms of this exemplary computer system. After reading this description, it will become apparent to a person skilled in the relevant art(s) how to implement the invention using other computer systems and/or computer architectures.

Computer system 600 also includes a main memory 608, preferably random access memory (RAM), and may also include a secondary memory 610. The secondary memory 610 may include, for example, one or more hard disk drives 612 and/or one or more removable storage drives 614, representing a floppy disk drive, a magnetic tape drive, an optical disk drive, etc. The removable storage drive 614 reads from and/or writes to a removable storage unit 618 in a well-known manner. Removable storage unit 618, represents a flash memory, floppy disk, magnetic tape, optical disk, etc. which is read by and written to by removable storage drive 614. As will be appreciated, the removable storage unit 618 includes a computer usable storage medium having stored therein computer software and/or data.

In alternative embodiments, secondary memory 610 may include other similar means for allowing computer programs or other instructions to be loaded into computer system 600. Such means may include, for example, a removable storage unit 622 and an interface 620. Examples of such may include a program cartridge and cartridge interface (such as that found in video game devices), a removable memory chip (such as Erasable Programmable Read-Only Memory (EPROM), Universal Serial Bus (USB) flash memory, or PROM) and associated socket, and other removable storage units 622 and interfaces 620 which allow software and data to be transferred from the removable storage unit 622 to computer system 600. In general, Computer system 600 is controlled and coordinated by operating system (OS) software, which performs tasks such as process scheduling, memory management, networking and I/O services.

There may also be a communications interface 624 connecting to the bus 602. Communications interface 624 allows software and data to be transferred between computer system 600 and external devices. Examples of communications interface 624 may include a modem, a network interface (such as an Ethernet card), a communications port, a PCMCIA slot and card, etc.

The computer 600 communicates with other computing devices over a data network based on a special set of rules (i.e., a protocol) to send data back and forth. One of the common protocols is TCP/IP (Transmission Control Protocol/Internet Protocol) commonly used in the Internet. In general, the communication interface 624 manages the assembling of a data file into smaller packets that are transmitted over the data network or reassembles received packets into the original data file. In addition, the communication interface 624 handles the address part of each packet so that it gets to the right destination or intercepts packets destined for the computer 600.

In this document, the terms “computer recordable storage medium”, “computer recordable medium” and “computer readable medium” are used to generally refer to media such as removable storage drive 614, and/or a hard disk installed in hard disk drive 612. These computer program products are means for providing software to computer system 600. The invention is directed to such computer program products.

The computer system 600 may also include an I/O interface 630, which provides the computer system 600 to access monitor, keyboard, mouse, printer, scanner, plotter, and alike.

Computer programs (also called computer control logic) are stored as application modules 606 in main memory 608 and/or secondary memory 610. Computer programs may also be received via communications interface 624. Such computer programs, when executed, enable the computer system 600 to perform the features of the present invention as discussed herein. In particular, the computer programs, when executed, enable the processor 604 to perform features of the present invention. Accordingly, such computer programs represent controllers of the computer system 600.

In an embodiment where the invention is implemented using software, the software may be stored in a computer program product and loaded into computer system 600 using removable storage drives 614, hard drive 612, or communications interface 624. The application module 606, when executed by the processor 604, causes the processor 604 to perform the functions of the invention as described herein.

The main memory 608 may be loaded with one or more application modules 606 that can be executed by one or more processors 604 with or without a user input through the I/O interface 630 to achieve desired tasks. In operation, when at least one processor 604 executes one of the application modules 606, the results (e.g., extracted natural vibration frequencies and associated mode shapes) are computed and stored in the secondary memory 610 (i.e., hard disk drive 612). For example, the SSD results can be saved to memory and reported to the user via the I/O interface 630 either as a list or a graph.

Although the present invention has been described with reference to specific embodiments thereof, these embodiments are merely illustrative, and not restrictive of, the present invention. Various modifications or changes to the specifically disclosed exemplary embodiments will be suggested to persons skilled in the art. For example, whereas four frequency bands are shown in FIG. 4A, the range of frequencies can be partitioned into other numbers, for example, 2, 3, 5, 6, 7, 8 etc. Additionally, whereas SSD has been shown and described as results of frequency-domain analysis, other types of responses can be used, for example, frequency response function, which is a result of unit amplitude harmonic load, and random vibration analysis, where the PSD (Power Spectral Density) of the load is used. In summary, the scope of the invention should not be restricted to the specific exemplary embodiments disclosed herein, and all modifications that are readily suggested to those of ordinary skill in the art should be included within the spirit and purview of this application and scope of the appended claims.

We claim:

1. A method of conducting frequency-domain structural analysis of a product made of at least in-part frequency-dependent material comprising:
receiving, in a computer system having one or more application modules installed thereon, a finite element analysis (FEA) model representing the product subjected to external harmonic excitations, the one or more application modules being configured for a modified mode-superposition technique in frequency-domain structural analysis and the external harmonic excitations being defined in a range of external excitation frequencies;
partitioning, by the one or more application modules, the range of frequencies into N frequency bands based on a predefined criterion, wherein N is a whole number greater than one;
designating, by the one or more application modules, a representative frequency for material property calculations and an eigensolution frequency range for upper and lower limits of subsequent eigensolution in each of the N frequency bands;
extracting, by the one or more application modules, N sets of natural vibration frequencies and associated mode shapes by performing N eigensolutions in respective N frequency bands, each eigensolution using the FEA model with material properties calculated from the corresponding representative frequency and using the upper and lower limits of the corresponding eigensolution frequency range of said each of the N frequency bands; and
obtaining, by the one or more application modules, steady-state dynamic (SSD) responses of the product via the modified mode-superposition technique that selects and uses corresponding set of the N sets of natural vibration frequencies and mode shapes dependent upon which one of the N frequency bands each of the external harmonic excitations is located.

2. The method of claim 1, wherein the FEA model contains a plurality of nodes connected by a plurality of finite elements, at least one finite element is defined to have frequency-dependent material property.

3. The method of claim 2, wherein the predefined criterion is to limit material property variation within a predetermined percentage.

4. The method of claim 1, wherein the representative frequency is a frequency chosen from said each of the N frequency bands.

5. The method of claim 1, wherein the eigensolution frequency range of said each of the N frequency bands comprises entire frequency range of said each of the N frequency bands plus extended range at either ends.

6. The method of claim 1, wherein the frequency-dependent material property comprises material density, Young's modulus, Poisson ratio.

7. The method of claim 1, wherein each of the external harmonic excitations comprises an amplitude and a phase angle.

8. A system for conducting frequency-domain structural analysis of a product made of at least in-part frequency-dependent material comprising:
an input/output (I/O) interface;
a memory for storing computer readable code for one or more application modules configured for a modified mode-superposition technique in frequency-domain structural analysis;
at least one processor coupled to the memory, said at least one processor executing the computer readable code in the memory to cause said one or more application modules to perform operations of:
receiving a finite element analysis (FEA) model representing the product subjected to external harmonic excitations and the external harmonic excitations being defined in a range of external excitation frequencies;
partitioning the range of frequencies into N frequency bands based on a predefined criterion, wherein N is a whole number greater than one;
designating a representative frequency for material property calculations and an eigensolution frequency range for upper and lower limits of subsequent eigensolution in each of the N frequency bands;
extracting N sets of natural vibration frequencies and associated mode shapes by performing N eigensolutions in respective N frequency bands, each eigensolution using the FEA model with material properties calculated from the corresponding representative frequency and using the upper and lower limits of the corresponding eigensolution frequency range of said each of the N frequency bands; and
obtaining steady-state dynamic (SSD) responses of the product via the modified mode-superposition technique that selects and uses corresponding set of the N sets of natural vibration frequencies and mode shapes dependent upon which one of the N frequency bands each of the external harmonic excitations is located.

9. The system of claim 8, wherein the FEA model contains a plurality of nodes connected by a plurality of finite elements, at least one finite element is defined to have frequency-dependent material property.

10. The system of claim 9, wherein the predefined criterion is to limit material property variation within a predetermined percentage.

11. The system of claim 8, wherein the representative frequency is a frequency chosen from said each of the N frequency bands.

12. The system of claim 8, wherein the eigensolution frequency range of said each of the N frequency bands comprises entire frequency range of said each of the N frequency bands plus extended range at either ends.

13. The system of claim 8, wherein the frequency-dependent material property comprises material density, Young's modulus, Poisson ratio.

14. A non-transitory computer readable storage medium containing instructions for controlling a computer system for conducting frequency-domain structural analysis of a product made of at least in-part frequency-dependent material by a method comprising:
receiving, in a computer system having one or more application modules installed thereon, a finite element analysis (FEA) model representing the product subjected to external harmonic excitations, the one or more application modules being configured for a modified mode-superposition technique in frequency-domain structural analysis and the external harmonic excitations being defined in a range of external excitation frequencies;
partitioning, by the one or more application modules, the range of frequencies into N frequency bands based on a predefined criterion, wherein N is a whole number greater than one;
designating, by the one or more application modules, a representative frequency for material property calculations and an eigensolution frequency range for upper and lower limits of subsequent eigensolution in each of the N frequency bands;
extracting, by the one or more application modules, N sets of natural vibration frequencies and associated mode shapes by performing N eigensolutions in respective N frequency bands, each eigensolution using the FEA model with material properties calculated from the corresponding representative frequency and using the upper and lower limits of the corresponding eigensolution frequency range of said each of the N frequency bands; and
obtaining, by the one or more application modules, steady-state dynamic (SSD) responses of the product via the modified mode-superposition technique that selects and uses corresponding set of the N sets of natural vibration frequencies and mode shapes dependent upon which one of the N frequency bands each of the external harmonic excitations is located.

15. The non-transitory computer readable storage medium of claim 14, wherein the FEA model contains a plurality of nodes connected by a plurality of finite elements, at least one finite element is defined to have frequency-dependent material property.

16. The non-transitory computer readable storage medium of claim 15, wherein the predefined criterion is to limit material property variation within a predetermined percentage.

17. The non-transitory computer readable storage medium of claim 14, wherein the representative frequency is a frequency chosen from said each of the N frequency bands.

18. The non-transitory computer readable storage medium of claim 14, wherein the eigensolution frequency range of said each of the N frequency bands comprises entire frequency range of said each of the N frequency bands plus extended range at either ends.

19. The non-transitory computer readable storage medium of claim 14, wherein the frequency-dependent material property comprises material density, Young's modulus, Poisson ratio.
